(19) United States
(12) Patent Application Publication
(10) Pub. No.: US 2008/0146459 A1
(43) Pub. Date: Jun. 19, 2008

(54) Protein Array and Process for Producing the Same

(76) Inventors: Masahiro Iwakura, Ibaraki (JP); Kiyonori Hirota, Ibaraki (JP)

Correspondence Address: MORGAN LEWIS & BOCKIUS LLP, 1111 PENNSYLVANIA AVENUE NW, WASHINGTON, DC, 20004, US

(21) Appl. No.: 10/553,626

(22) PCT Filed: Apr. 9, 2004
(86) PCT No.: PCT/JP04/05150

§ 371 Date: Aug. 30, 2006

(30) Foreign Application Priority Data
Apr. 10, 2003 (JP) 2003-106450

(51) Int. Cl. C40B 40/10; C40B 50/18

(52) U.S. Cl. 506/18; 506/32

(57) ABSTRACT

A protein array having a protein aligned and immobilized in high density and in uniformly oriented form is produced by introducing a polymer compound having a primary amino group as a repeating unit on the surface of a planar substrate so as to obtain a substrate for protein array and binding the carboxyl terminal of the main chain of a protein with the primary amino group of the polymer compound on the substrate.

### TECHNICAL FIELD

The present invention relates to a substrate for a protein array, a protein array, and a process for producing the protein array.

### BACKGROUND ART

Heretofore, it is attempted to utilize immobilization of a protein at a specific place on a planar substrate as an enzyme electrode, a protein array, or the like. For example, the enzyme electrode is used to clarify the amount of a substrate (glucose or the like), which is difficult to measure directly, by immobilizing an enzyme on a planar electrode and measuring a reaction product of the enzyme with the electrode. Moreover, a so-called protein array (chip) in a narrow sense, which has recently been developed rapidly, is one wherein many kinds of proteins are aligned in order and immobilized at specific places on a small substrate and subjects which interact therewith are selected and investigated at once. The performance of such a protein array depends on properties and functions of the proteins in an immobilized state and density of the proteins to be immobilized, and they, in turn, depend on an immobilization process of the proteins and properties of the substrate.

As the immobilization process, at an early stage, utilizing reactivity between a compound having a plurality of functional groups, such as glutaraldehyde, and a side chain of an amino acid constituting the protein, the protein is immobilized on the substrate by forming a crosslinked bond between the proteins and between the protein and the substrate. In this method, however, the properties of the protein immobilized are not homogeneous and there is a possibility that the properties of the protein are inhibited as a result of immobilization.

In order to solve these problems, there has been devised a process wherein SAM (self-film-forming ability molecule) having a functional group is placed on the substrate and a bond is formed between the functional group and a side chain of an amino acid constituting the protein to immobilize the protein, and the process has been used for producing protein arrays. In this method, however, only almost monomolecular protein can be immobilized on the substrate in the thickness direction and thus immobilization density of the protein per unit surface area is limited to about several ng (several tens fmoles)/mm². This fact results in a large limitation in its utilization, for example, a method applicable to detection of the aligned proteins themselves or substances specifically binding to the aligned proteins is very much restricted.

On the other hand, heretofore, the present inventors have developed a process for immobilization through the carboxyl group at the carboxyl terminal of a protein main chain utilizing an amide bond-forming reaction through a cyanocysteine residue (see JP-A-10-45798) and further developed an immobilization means wherein a protein is bound to a primary amino group on a substrate at one portion of the carboxyl terminal and through the main chain (Japanese Patent No. 3047020).

According to such a means, by binding a protein at one portion of the carboxyl terminal and through the main chain, there are obtained advantages that reversibility of the modification can be enhanced and also immobilized enzymes capable of thermal sterilization of immobilized proteins can be produced.

However, in the method, the density of the primary amino groups on the substrate is low and hence the immobilized density of proteins is also low, so that the method has been not yet fully satisfactory in view of the performance in the case of utilization as a protein array.

### DISCLOSURE OF THE INVENTION

An object of the present invention is to develop a means capable of increasing an immobilized amount per unit area, immobilizing a protein in high density in a small region on an array substrate, and thereby increasing the number of immobilized regions of proteins on the substrate by adopting the above means for orientation control and immobilization at one portion of the carboxyl terminal of a protein main chain and further devolving the means, in the production of a protein array. Thereby, the present invention intends to contribute expansion of the utilization field of protein arrays through, for example, expansion of detection system, enhancement of detection sensitivity, and the like in protein arrays.

As a result of extensive studies for the purpose of increasing the immobilized amount per unit area (i.e., immobilized density of proteins) to 100 times to 1000 times a monomolecular adsorption level (i.e., about several μg/mm²) at the production of a protein array by aligning and immobilizing a protein in order on a planar substrate in order to solve the above problems, the present inventors have found that the protein can be immobilized in an extremely high density with aligning the protein in order on the planar substrate by introducing a polymer compound having a primary amino group in a repeating unit into a surface of the planar substrate and binding the carboxyl terminal of a protein main chain to the primary amino group of the polymer compound introduced. Thus, they have accomplished the present invention.

Namely, the present invention relates to the following (1) to (13).

### (1) A substrate for a protein array, comprising a substrate to which a polymer compound having a primary amino group in a repeating structure is bound.

### (2) The substrate for a protein array according to claim 1, wherein the substrate to which the polymer compound having a primary amino group in a repeating structure is bound has water absorbability.

### (3) The substrate for a protein array according to any one of the above (1) to (3), wherein the polymer compound having a primary amino group in a repeating structure is polyallylamine.

### (4) The substrate for a protein array according to any one of the above (1) to (3), wherein the polymer compound having a primary amino group in a repeating structure is polylysine.

(5) A protein array comprising a protein represented by formula (I) aligned and immobilized on the substrate for a protein array according to any one of the above (1) to (4) so that the carboxyl terminal of the protein main chain represented by formula (I) is immobilized by a peptide bond to the primary amino group of the polymer compound bound to the substrate:

NH₂—R₁—COOH (I)

wherein R₁ represents any amino acid sequence.

(6) A protein array comprising a protein represented by formula (IV) aligned and adsorbed on the substrate for a protein array according to any one of the above (1) to (4) so that the protein represented by the above formula (IV) is immobilized in an adsorbed state:

NH₂—R₁—CONH—R₂—COOH (IV)

wherein R₁ represents any amino acid sequence; and R₂ represents an amino acid sequence which is negatively-charged strongly at around neutral and is capable of acidifying the isoelectric point of the protein represented by the above formula (IV).

### (7) The protein array according to the above (5) or (6), wherein the protein to be immobilized has an amino acid sequence of a linker peptide.

### (8) A process for producing a protein array comprising a protein represented by formula (I) aligned and immobilized on the substrate for a protein array according to any one of the above (1) to (4):

NH₂—R₁—COOH (I)

wherein R₁ represents any amino acid sequence,

said method comprising reacting a protein represented by formula (II):

NH₂—R₁—CO—NH—CH(CH₂—SCN)—CO—NH—R₂—COO (II)

wherein R₁ represents any amino acid sequence; and R₂ represents an amino acid sequence which is negatively-charged strongly at around neutral and is capable of acidifying the isoelectric point of the protein represented by the above formula (II),

with a polymer compound on the substrate for a protein array to thereby bind the carboxyl terminal of the protein main chain of formula (II) to a primary amino group of the polymer compound by a peptide bond.

### (9) The process for producing a protein array according to the above (8), wherein the protein represented by formula (II) is formed by aligning and adsorbing a protein represented by formula (III):

NH₂—R₁—CONH—CH(CH₂—SH)—CO—NH—R₂—COOH (III)

wherein R₁ represents any amino acid sequence; and R₂ represents an amino acid sequence which is negatively-charged strongly at around neutral and is capable of acidifying the isoelectric point of the protein represented by the above formula (III),

on a substrate for a protein array, followed by reaction with a cyanation reagent.

### (10) A process for producing a protein array, which comprises aligning and adsorbing a protein represented by formula (IV):

NH₂—R₁—CONH—R₂—COOH (IV)

wherein R₁ represents any amino acid sequence; and R₂ represents an amino acid sequence which is negatively-charged strongly at around neutral and is capable of acidifying the isoelectric point of the protein represented by the above formula (IV),

on the substrate for a protein array according to any one of the above (1) to (4) to thereby immobilize the protein in an adsorbed state.

### (11) The process for producing a protein array according to any one of the above (8) to (10), wherein the protein to be immobilized has an amino acid sequence of a linker peptide.

### (12) The process for producing a protein array according to any one of the above (8) to (11), wherein a means for aligning the protein on the substrate for a protein array is a microcapillary or a needle-like article.

### (13) The process for producing a protein array according to any one of the above (8) to (11), wherein a means for aligning the protein on the substrate for a protein array is an ink-jet process.

### BRIEF DESCRIPTION OF THE DRAWINGS

FIG. 1 is a drawing showing a result of coloring reaction of nylon film (A) not treated with polyallylamine and nylon film (B) treated with polyallylamine using TNBS.

FIG. 2 is a drawing showing a result of coloring reaction of nitrocellulose film (A) not treated with polyallylamine and nitrocellulose film (B) treated with polyallylamine using TNBS.

FIG. 3 is a drawing showing a result of spotting three kinds of concentrations, i.e., 2 mg/ml, 1 mg/ml and 0.5 mg/ml of a green fluorescent protein in an amount of 4 μl each on four places of each of polyallylamine-bound nylon film substrate (A) and polyallylamine-bound nitrocellulose film substrate (B) using a capillary having an opening of a diameter of about 0.5 mm and immobilizing the protein and a result of spotting the protein in the same manner on nylon film (C) and nitrocellulose film (D) not treated with polyallylamine and immobilizing the protein.

FIG. 4 is a drawing showing a result of spotting three kinds of concentrations, i.e., 0.5 mg/ml, 0.25 mg/ml and 0.125 mg/ml of a red fluorescent protein in an amount of 4 μl each on four places of each of polyallylamine-bound nylon film substrate (A) and polyallylamine-bound nitrocellulose film substrate (B) using a capillary having an opening of a diameter of about 0.5 mm and immobilizing the protein and a result of spotting the protein in the same manner on nylon film (C) and nitrocellulose film (D) not treated with polyallylamine and immobilizing the protein.

FIG. 5 is a drawing showing a result of spotting two kinds of concentrations, i.e., 0.4 mg/ml and 0.2 mg/ml of a red fluorescent protein in an amount of 0.5 μl each on three places of polyallylamine-bound nylon film substrate for the protein of 0.4 mg/ml and two places thereof for the protein of 0.2 mg/ml using a capillary having an opening of a diameter of about 0.2 mm and immobilizing the protein.

### BEST MODE FOR CARRYING OUT THE INVENTION

According to the present invention, there is provided a protein array by binding a polymer compound having a primary amino group in a repeating structure on a substrate surface to produce a substrate for a protein array, adsorbing a protein at a specific position on the substrate for a protein array utilizing the primary amino group on the polymer compound, and further binding the carboxyl terminal of a protein main chain to the primary amino group to align and immobilize the protein on the substrate. In the present invention, by using the above polymer compound, the density of the primary amino group on the substrate surface is increased, the protein can be immobilized in an extremely small region in high density and in homogeneously oriented state with retaining its function, and also the number of immobilized regions of the protein on the array substrate can be increased.

In the present invention, the protein to be immobilized on the substrate for the protein array is not particularly limited and, for example, any proteins such as in vivo physiologically active protein, enzyme and antigen can be used. Moreover, in the present specification, a peptide may be included as the protein to be immobilized.

The following will describe the means for producing a protein array by binding a protein to the primary amino group of the polymer compound on the substrate surface by a peptide bond in detail.

### 1. Substrate for Protein Array

In order to achieve the above object of the present invention, it is required for the substrate for the protein array to contain the primary amino group in a high density sufficient to be able to adsorb about several μg/mm² or more of a negatively-charged protein through ionic interaction. However, a substrate satisfying the performance cannot be found in commercially available products. Thus, in the present invention, the primary amino group is introduced in high density by introducing a polymer compound having a repeating structure of the primary amino group into a planar substrate.

Examples of a form of the planar substrate for introducing the polymer compound include a plate-like film, a sheet-like one and the like, and specific examples thereof include a nylon film, a nitrocellulose film, glass having a binding ability to the polymer compound, and the like. For example, Hybond N (trade name; a nylon film commercially available from Pharmacia), Transblot (trade name; a nitrocellulose film commercially available from Biolad), and the like are commercially available and they can be utilized. Also, since the protein to be used for immobilization is mainly used as a solution obtainable by dissolving it in an aqueous buffer, it is desirable for the planar substrate to have hydrophilicity and water absorbability.

As the polymer compound in the present invention, any compound can be used, so long as it contains a primary amino group in a repeating structure and portions other than the primary amino group are not reactive with a side chain or an α-amino group at the amino terminal or the carboxyl group at the carboxyl terminal of the protein to be immobilized.

Examples of the polymer compound having a primary amino group in a repeating structure include those having a polyalkylene chain, a polyamide chain, a polyester chain, a polystyrene chain, or the like and the compound has a repeating structure represented by the following formula:

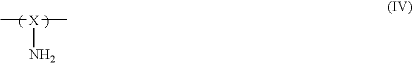

wherein X represents, for example, a monomer residue constituting a polyalkylene chain, a polyamide chain, a polyester chain, a polystyrene chain, or the like; and the NH₂ group may be a group contained in the monomer residue or a group contained in a side chain branched from the main chain of the polymer compound.

In the present invention, among these polymer compounds, polyallylamine is exemplified as the compound having a polyalkylene chain. The polymer compound has a high primary amine content per unit weight and hence can be used as a preferable compound in the present invention. Moreover, in the present invention, the polymer compound is not limited thereto and, for example, a copolymer of a vinyl compound having a primary amino group in a side chain with other vinyl compound or various polymer compounds such as polylysine can be utilized.

The polymer compound having a primary amino group in a repeating structure can be bound to the planar substrate by various methods. The binding means may be any one, so long as it can support the above polymer compound on the substrate surface stably, and examples include chemical or physical means such as an ionic bond, a covalent bond, a hydrophobic bond, adsorption, adhesion, and coating. The means may be selected from these means depending on the material of the substrate. As a specific example of the binding means, when a cellulose film is used as the substrate, the film can be converted into an active state toward a primary amine by treatment with BrCN. Moreover, for a glass surface, the glass surface can be treated with a silylating compound having an aldehyde group to form a bond of a Schiff base between the aldehyde group and a primary amine and the bond can be reduced to form a strongly bound article. Furthermore, when a nylon film is used, the nylon film is immersed in an aqueous solution containing a polymer compound repeatedly having an appropriate concentration of a primary amine and thoroughly equilibrated to make the surface density homogeneous. Thereafter, the film is washed with water and air-dried and then it is irradiated with an ultraviolet ray for several tens seconds, whereby a strong bond which is not cleaved by ordinary operations at room temperature, washing with 1M KCl, or the like can be formed.

In any of the binding operations, by controlling the amount of the polymer compound having a primary amino group to be introduced into the substrate surface, the surface density of the primary amino group utilizable for the immobilization reaction of the protein can be changed.

### 2. Synthesis of Protein to be Immobilized on Substrate

In the present invention, a protein is immobilized on the substrate utilizing an amide bond-forming reaction through a cyanocysteine residue obtained by cyanation of the sulfhydryl group of a cysteine residue in the protein.

The amide bond-forming reaction through a cyanocysteine residue is represented by reaction (a):

NH₂—R—CO—NH—CH(CH₂—SCN)—CO—W+NH₂—B→NH₂—R—CO—NH—B Reaction (a)

wherein R represents a chain of any amino acid residues; X represents OH, any amino acid residue or a chain of any amino acid residues; and NH₂—B represents any compound having a primary amino group.

The amide bond-forming reaction occurs competitively with a peptide chain-cleavage reaction represented by reaction (b):

NH₂—R—CO—NH—CH(CH₂—SCN)—CO—W+H₂O→NH₂—R—COOH+Z Reaction (b)

wherein R represents a chain of any amino acid residues; W represents OH, any amino acid residue or a chain of any amino acid residues; and Z represents a 2-iminothiazoline-4-carboxylyl derivative (see G. R. Jacobson, M. H. Schaffer, G. R. Stark, T. C. Vanaman, J. Biological Chemistry, 248, 6583-6591 (1973)) and a reaction of converting the cyanocysteine residue into dehydroalanine through a β-elimination reaction wherein a thiocyano group is eliminated represented by reaction (c):

NH₂—R—CO—NH—CH(CH₂—SCN)—CO—W NH₂—R—CO—NH—C(CH₂)—CO—W Reaction (c)

wherein R represents a chain of any amino acid residues; and W represents OH or any amino acid residue or a chain of any amino acid residues (see, Y. Degani, A. Patchornik, Biochemistry, L3, 1-11 (1974)),

and hence there arises a problem of reaction yields. With regard to the problem, the present inventors have found that an amide bond can be efficiently formed with suppressing side reactions by using a protein represented by formula (II):

NH₂—R₁—CO—NH—CH(CH₂—SCN)—CO—NH—R₂—COOH (II)

wherein R₁ represents any amino acid sequence; R₂ represents an amino acid sequence which is negatively-charged strongly at around neutral and is capable of acidifying the isoelectric point of the protein (II); and n represents a natural number,

and, after the carboxyl terminal side of the protein is adsorbed to the primary amino group side on the substrate by electrostatic interaction, carrying out the amide bond-forming reaction of the above reaction formula (a). Also, they have developed a process for producing an immobilized protein using the above amide formation (see JP-A-2003-344396 and Japanese Patent No. 3047020).

In the present invention, also, this process is fundamentally used.

Accordingly, in the present invention, at immobilization of a protein represented by formula (I):

NH₂—R₁—COOH (I)

wherein R₁ represents any amino acid sequence,

on a substrate for a protein array, a protein having a sequence represented by formula (III):

NH₂—R₁—CO—NH—CH(CH₂—SH)—CO—NH—R₂—COOH (II)

wherein R₁ represents any amino acid sequence; and R₂ represents a chain of any amino acid residues which is negatively-charged strongly at around neutral and is capable of acidifying the isoelectric point of the substance of the above formula (III),

is first synthesized.

In the structure of the protein represented by formula (III), the amino acid sequence R₂ is negatively-charged strongly at around neutral and thus there occurs static interaction with the above polymer compound having a primary amino group in a repeating structure which positively charged under a neutral condition. Therefore, the protein represented by formula (III) can efficiently bind to the carboxyl terminal of the protein main chain to the primary amino group through a peptide (amide) bond-forming reaction to be described below by adsorption of the carboxyl terminal side to the primary amino group side of the polymer compound on the substrate.

Furthermore, in the present invention, the carboxyl terminal side of R₁ in the above formula (III) may contain an amino acid sequence which becomes a linker peptide. The protein in this case is represented by the following formula (V):

NH₂—R₁—CO—NH—Rₐ—CO—NH—CH(CH₂—SH)—CO—NH—R₂—COOH (V)

wherein R₁ and R₂ have the same meanings as R₁ and R₂, respectively, of the above formula (III); and Rₐ represents an amino acid sequence which becomes a linker peptide between the peptide to be immobilized and the above polymer compound-bound substrate. Rₐ is optional and both of the kind and number of the amino acid(s) are not limited. For example, Gly-Gly-Gly-Gly-Gly-Gly or the like is one of the most simple sequences.

In the present invention, such a protein can be easily produced by a known genetic engineering technique.

For example, when a gene DNA encoding a fused protein represented by the above formula (V) is prepared, it can be obtained by binding a gene DNA encoding the protein represented by formula (1) to a gene DNA encoding a peptide sequence represented by formula (VI):

NH₂—Rₐ—CO—NH—CH(CH₂—SH)—CO—NH—R₂—COOH (VI)

wherein Rₐ has the same meaning as Rₐ in the above formula (V); and R₂ represents a chain of any amino acid residues which is negatively-charged strongly at around neutral and is capable of acidifying the isoelectric point of the substance of formula (III),

to synthesize a gene DNA encoding the fused protein represented by the above formula (V), incorporating the synthesized DNA into an appropriate expression vector, introducing the resulting vector into a host such as Escherichia coli, expressing the protein in the introduced host, and then separating and purifying the expressed protein. Such a fused protein can be carried out utilizing a known technique (e.g., see M. Iwakura et al., J. Biochem. 111, 37-45 (1992)). Moreover, the above protein can be also produced by combination of a genetically engineering technique and a conventional protein-synthesizing technique or a protein-synthesizing technique alone.

On the other hand, as R₂ in the above formula (III) or (V), a sequence containing a large number of aspartic acid and/or glutamic acid is suitable. Preferably, it is sufficient to design a sequence containing a large number of aspartic acid and/or glutamic acid so that the isoelectric point of a cyanated protein represented by the following formula (I) or (VII) falls within the range of 4 to 5. As a referable example of such sequences, alanyl-polyaspartic acid may be mentioned. This is because introduction of alanine as an amino acid residue following the cyanocysteine residue facilitates occurrence of the amide bond-forming reaction through the cyanocysteine residue and the carboxyl group of aspartic acid is most acidic among amino acid side chains.

### 3. Immobilization of Protein

Next, in the present invention, the protein for immobilization produced as above is aligned and adsorbed on the substrate for a protein array. The process is not particularly limited and any process can be employed, so long as the process can spot a protein solution on a specific place on the substrate. For example, there are processes using a needle-like article such as pin, ink-jet or capillary, and any process may be used. Also, it is possible to use a picking robot. The following will describe a spotting process using a capillary as one example.

It is possible to spot a solution of the protein for immobilization represented by formula (III) in a suitable amount at an intended place by charging the protein solution into a capillary and applying an appropriate pressure from above. Moreover, when the substrate for immobilization has a nature of water absorbability, a protein solution in an amount of about 10 μl may be rapidly absorbed on the substrate without applying any pressure from above. At that time, the solvent of the protein solution diffuses in all directions with the spotted place being the center but the protein remains at the spotted place since it adsorbs to the primary amine through static interaction. Therefore, it is possible to adsorb the protein in a small region in high density. Furthermore, by controlling the position to be spotted, the protein can be aligned and immobilized in any pattern. This can be also achieved by computer control in such a manner that a pattern manufactured on a computer is printed by means of an ink-jet printer. Therefore, any process is applicable, so long as it is usable for alignment and it is obvious that the present invention is not limited thereby.

### 4. Immobilization of Protein

As described as an alternative process, the above spotted protein after adsorption and immobilization may be used as a protein array as it is but the protein is bound to the substrate through only a non-covalent bond such as static interaction at this stage and thus the binding strength is low, so that an amide bond is further formed between the carboxyl group of the carboxyl terminal of the protein and the primary amino group of the polymer on the substrate in order to strongly immobilize the protein. For the occurrence of the reaction, it is necessary to convert the sulfhydryl group of the cysteine residue introduced into the carboxyl terminal of the protein for immobilization into a cyanocysteine through cyanation.

For achieving the bond, it is necessary to convert the sulfhydryl group of the cysteine residue in the protein of the above formula (III) or (V) into a cyanocysteine through cyanation and the cyanated protein obtained by the cyanation of formula (III) is a protein represented by the following formula (II):

NH₂—R₁—CO—NH—CH(CH₂—SCN)—CO—NH—R₂—COOH (II)

wherein R₁ and R₂ have the same meanings as R₁ and R₂, respectively, of the above formula (III); and R₁ represents any amino acid sequence; and R₂ represents an amino acid sequence which is negatively-charged strongly at around neutral and is capable of acidifying the isoelectric point of the substance of formula (II).

Moreover, the cyanated protein obtained by the cyanation of formula (V) is a protein represented by the following formula (VII):

NH₂—R₁—CO—NH—Rₐ—CO—NH—CH(CH₂—SCN)—CO—NH—R₂—COOH (VII)

wherein R₁, R₂, and Rₐ have the same meanings as R₁, R₂, and Rₐ, respectively, of the above formula (V); R₁ represents any amino acid sequence; and R₂ represents an amino acid sequence which is negatively-charged strongly at around neutral and is capable of acidifying the isoelectric point of the substance of formula (II); and Rₐ represents an amino acid sequence which becomes a linker peptide between the protein to be immobilized and the above polymer compound-bound substrate.

The cyanation reaction can be carried out using a commercially available cyanation reagent. A process using 2-nitro-5-thiocyanobenzoic acid (NTCB) (see Y. Degani, A. Ptchornik, Biochemistry, 13, 1-11 (1974)) or 1-cyano-4-dimethylaminopyridinium tetrafluoroborate (CDAP) as a cyanation reagent is usually convenient.

The cyanation using NTCB can be efficiently carried out in a 10 mM phosphate buffer at pH 7.0. After the cyanation, an immobilization reaction proceeds by making the solvent weakly alkaline. Namely, an amide bond is formed between the carboxyl group of the amino acid residue just before the cyanocysteine residue and the primary amino group of the substrate. This is achieved by replacing the buffer with a 10 mM borate buffer at pH 9.5.

The conversion of the sulfhydryl group of the cysteine residue into cyanocysteine necessary for the above immobilization reaction may be carried out, as found by the present inventors, before or after the adsorption of the protein to the substrate to be immobilized or simultaneously with the adsorption (see JP-A-2002-148950). Since the protein after cyanation represented by formula (II) or (VII) also has an amino acid sequence which is negatively-charged strongly at around neutral, even when the protein after cyanation is aligned and adsorbed on the substrate, the carboxyl terminal side of the protein main chain is adsorbed to the primary amino group side of the polymer compound on the substrate and only the carboxyl terminal of the protein main chain is bound to the primary amino group, whereby a protein array can be obtained wherein the protein is aligned and immobilized in a homogeneous state and in high density.

Moreover, the reactions involving cyanocysteine used in the present invention may include occurrence of hydrolysis reactions as side reactions but since all the reaction products formed from such side reactions dissolve in a solvent, the side reaction products can be removed after the reaction by washing the protein array after the protein immobilization reaction with a suitable solvent.

In each position aligned and immobilized on the protein array of the present invention obtained by the above means, as shown by the following formula (VII) or (VIII), one portion of the carboxyl terminal of the protein main chain is bound to the primary amino group of the repeating structure of the polymer compound and the polymer compound is bound on the substrate with an ionic bond, a covalent bond, a hydrophobic bond or a chemical or a physical binding means such as adsorption, adhesion or coating.

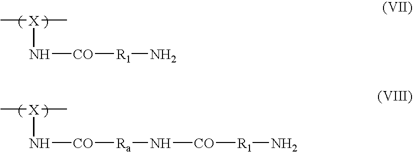

In the above, a means of producing a protein array by binding a protein to the primary amino group of the polymer compound on the substrate surface by a peptide bond is described in detail but as an alternative process, such a chemical bond can be omitted in the protein array of the present invention. Namely, as is apparent from the above, when an amino acid sequence which is negatively-charged strongly at around neutral and capable of acidifying the isoelectric point of the protein is added to the protein to be immobilized, static interaction may occur between the negatively-charged amino acid sequence and the polymer compound having the positively charged primary amino group and the protein at the carboxyl terminal side is adsorbed to the primary amino group side of the polymer compound on the substrate. Therefore, it is possible to immobilize the protein on the substrate even when a chemical bond is not involved.

In this case, using a protein represented by formula (IV):

NH₂—R₁—CONH—R₂—COOH (IV)

wherein R₁ represents any amino acid sequence; and R₂ represents an amino acid sequence which is negatively-charges strongly at around neutral and is capable of acidifying the isoelectric point of the protein represented by the above formula (IV),

it is aligned and adsorbed on a substrate for a protein array to effect immobilization. The immobilization by absorption alone has advantages that cysteine is not required in the added sequence of the protein and the cyanation and the amide-forming reaction are also not required as well as production of a protein array is extremely simple and convenient although the binding strength is low.

As above, using the substrate for a protein array of the present invention and the protein for immobilization, as shown in Examples, a protein array wherein the protein is immobilized in a high density of about several μg/mm² can be produced by effecting immobilization according to the above operations.

### EXAMPLES

The following will describe the present invention with reference to Examples but the present invention is not limited to these Examples.

In the present Examples, as a polymer compound having a primary amino group in a repeating structure, L-type polyallylamine commercially available from Nitto Boseki Co., Ltd. was used. It was bound to a nylon film (Hybond N, purchased from Pharmacia) and a nitrocellulose film (Transblot, purchased from Bio-Rad) which are flat substrates to produce substrates for protein arrays.

In the present invention, the proteins prepared for use in immobilization are a protein (SEQ ID NO:3) wherein an amino acid sequence (Gly-Gly-Gly-Gly-Gly-Gly) as a linker peptide part, cysteine (Cys), and an amino acid sequence (Ala-Asp-Asp-Asp-Asp-Asp-Asp) for acidifying the isoelectric point of the resulting protein are sequentially added to a green fluorescent protein (SEQ ID NO:1) and a protein (SEQ ID NO:4) wherein a sequence similar to the above is added to a red fluorescent protein (SEQ ID NO:2). Thus, the proteins to be immobilized are proteins wherein the linker peptide is added to each of the green fluorescent protein and the red fluorescent protein.

The green fluorescent protein and the red fluorescent protein are used in the present Examples since they show yellow color and red color, respectively, under natural light and hence there is a convenience that the experiment can be monitored visually. However, it has been already found that the immobilization reaction utilized in the present invention does not depend on the kind of the protein (see JP-A-2003-344396 and Japanese Patent No. 3047020).

### Example 1

### (1) Production of Substrate for Protein Array Using Nylon Film

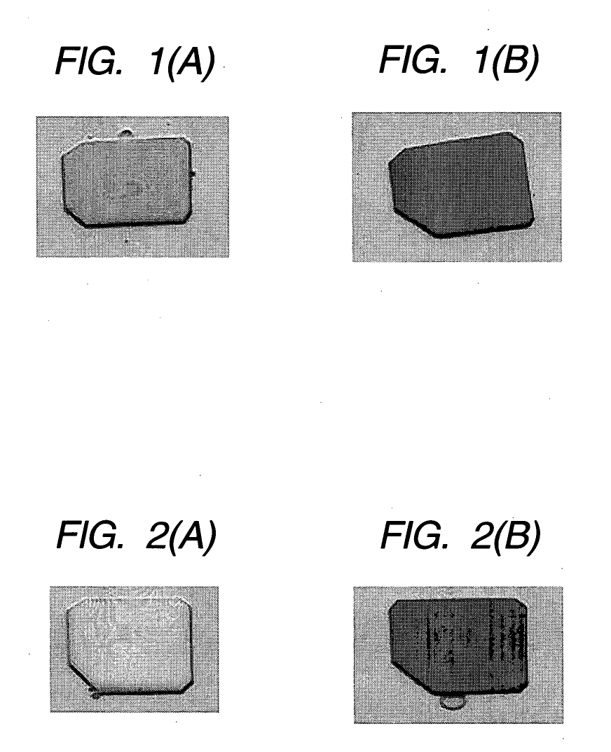

A nylon film (about 4 cm×3 cm) was immersed in an aqueous solution containing 1% L-type polyallylamine and maintained therein at room temperature under gentle stirring overnight (12 hours or more), whereby polyallylamine was thoroughly infiltrated. After washed with pure water twice and air-dried for several hours, the film was irradiated with an ultraviolet ray using transilluminater (UVP, 360 nm) for 30 seconds to bind polyallylamine to the nylon film. In order to confirm the introduction of the primary amino group into the nylon film, it was investigated by a coloring reaction using trinitrobenzenesulfonic acid (TNBS; 2,4,6-trinitrobenzenesulfonic acid) (reference: Robert Fields, Methods in Enzymology, 25, 464-468 (1971)). FIG. 1 shows a result of coloring reaction of nylon film (A) not treated with polyallylamine and nylon film (B) treated with polyallylamine using TNBS. The untreated nylon film was colored yellow (FIG. 1A) but the nylon film treated with polyallylamine was very strongly colored red, which is a characteristic color to a primary amine, and showed a high primary amine content (FIG. 1B).

Also, the substrate produced showed no change in immobilization ability of a protein even when it was allowed to stand at room temperature for at least one week.

### (2) Production of Substrate for Protein Array Using Nitrocellulose Film

In the same manner as in (1) of Example, a nitrocellulose film (about 4 cm×3 cm) was immersed in an aqueous solution containing 1% L-type polyallylamine and maintained therein at room temperature under gentle stirring overnight (12 hours or more), whereby polyallylamine was thoroughly infiltrated. After washed with pure water twice and air-dried for several hours, the film was irradiated with an ultraviolet ray using transilluminater (UVP, 360 nm) for 30 seconds to bind polyallylamine to the nitrocellulose film. In order to confirm the introduction of the primary amino group into the nitrocellulose film, it was investigated by a coloring reaction using TNBS. FIG. 2 shows a result of coloring reaction of nitrocellulose film (A) not treated with polyallylamine and nitrocellulose film (B) treated with polyallylamine using TNBS. The untreated nitrocellulose film was observed not to be colored (FIG. 2A) but the nitrocellulose film treated with polyallylamine was very strongly colored with red, which is a characteristic color to a primary amine, and showed a high primary amine content (FIG. 2B). Also, the substrate produced showed no change in immobilization ability of a protein even when it was allowed to stand at room temperature for at least one week.

### (3) Preparation of Green Fluorescent Protein for Immobilization

A DNA sequence encoding an amino acid sequence wherein eight amino acid sequences at the carboxyl terminal side of the green fluorescent protein (SEQ ID NO:1) was combined with an amino acid sequence represented by Gly-Gly-Gly-Gly-Gly-Gly-Cys-Ala-Asp-Asp-Asp-Asp-Asp-Asp was chemically synthesized. PCR was carried out using this DNA sequence and a chemically synthesized DNA sequence encoding eight amino acid sequences at the amino terminal side of the green fluorescent protein as primer DNAs to synthesize a gene encoding an amino acid sequence corresponding to the green fluorescent protein for immobilization (SEQ ID NO:3), which was incorporated into an EcoRI-Hind III side of an expression vector pUC18 to produce a recombinant plasmid. The plasmid is introduced into Escherichia coli JM109 and expressed, followed by separation and purification as described below.

Also, the gene encoding the green fluorescent protein (SEQ ID NO: 1) was purchased as a commercially available one from QUANTUM and used but the present invention is not limited by the method for obtaining the gene.

The recombinant Escherichia coli expressing the green fluorescent protein for immobilization was cultured in a 2 L medium containing 20 g of sodium chloride, 20 g of yeast extract, 32 g of tryptone, and 100 mg of ampicillin sodium at 37° C. overnight and then the culture liquid was centrifuged at a low speed (5000 rpm) for 20 minutes to obtain about 5 g (wet weight) of fungus body. The fungus body was suspended in a 10 mM phosphate buffer (pH 7.0) (buffer 1) containing 40 mL of 1 mM ethylenediamine tetraacetate (EDTA) and, after the fungus body was destroyed on a French press, the mixture was centrifuged (20,000 rpm) for 20 minutes to separate a supernatant. Streptomycin sulfate was added to the resulting supernatant so that the final concentration was 2%. After stirred at 4° C. for 20 minutes, the mixture was centrifuged (20,000 rpm) for 20 minutes to separate a supernatant. Ammonium sulfate was added to the resulting supernatant so that the final concentration was 40%. After stirred at 4° C. for 20 minutes, the mixture was centrifuged (20,000 rpm) for 20 minutes to separate a supernatant. Ammonium sulfate was added to the resulting supernatant so that the final concentration was 90%. After stirred at 4° C. for 30 minutes, the mixture was centrifuged (20,000 rpm) for 20 minutes to separate a precipitate. The precipitate was dissolved in 40 mL of buffer 1 and the solution was dialyzed against 4 L of buffer 1 three times.

The dialyzed protein solution was applied to a column (200 ml) of DEAE TOYOPEARL (purchased from Tosoh Corp.) equilibrated with buffer 1 containing 50 mM KCl beforehand. After 500 mL of buffer 1 containing 50 mM KCl was charged, proteins were eluted using buffer 1 with a gradient of KCl concentration of 50 mM to 500 mM to separate a fraction containing the green fluorescent protein for immobilization. After the separated fraction was dialyzed against buffer 1, the resulting fraction was applied to a column (200 ml) of Super Q TOYOPEARL (purchased from Tosoh Corp.) equilibrated with buffer 1 containing 50 mM KCl beforehand. After 500 mL of buffer 1 containing 50 mM KCl was charged, proteins were eluted using buffer 1 with a gradient of KCl concentration of 50 mM to 500 mM to separate a fraction containing the green fluorescent protein for immobilization. At this stage, the protein could be homogenized and about 100 mg of a homogeneous green fluorescent protein for immobilization was obtained.

The resulting protein was stored against buffer 1 and the dialyzed sample was stored at 4° C. and used in the following experiments. The concentration of the green fluorescent protein for immobilization was determined based on absorbance at 280 nm using a molecular extinction coefficient of the green fluorescent protein represented by SEQ ID NO: 1 of 22,000.

### (4) Preparation of Red Fluorescent Protein for Immobilization

A DNA sequence encoding an amino acid sequence wherein eight amino acid sequences at the carboxyl terminal side of the red fluorescent protein (SEQ ID NO:2) was combined with an amino acid sequence represented by Gly-Gly-Gly-Gly-Gly-Gly-Cys-Ala-Asp-Asp-Asp-Asp-Asp-Asp was chemically synthesized. PCR was carried out using this DNA sequence and a chemically synthesized DNA sequence encoding eight amino acid sequences at the amino terminal side of the red fluorescent protein (SEQ ID NO:1) as primer DNAs to produce a gene encoding an amino acid sequence corresponding to the red fluorescent protein for immobilization (SEQ ID NO:3), which was incorporated into an EcoRI-Hind III side of an expression vector pUC18 to produce a recombinant plasmid. The plasmid was introduced into Escherichia coli JM109 and expressed, followed by separation and purification as described below. Also, when a gene encoding the protein represented by SEQ ID NO:2 can be obtained, those skilled in the art can easily produce the protein for immobilization according to the present invention represented by SEQ ID NO:4. Also, the gene encoding the red fluorescent protein (SEQ ID NO:2) was purchased as a commercially available one from QUANTUM and used but it is obvious that the present invention is not limited by the method for obtaining the gene.

The recombinant Escherichia coli expressing the red fluorescent protein for immobilization was cultured in a 2 L medium containing 20 g of sodium chloride, 20 g of yeast extract, 32 g of tryptone, and 100 mg of ampicillin sodium at 37° C. overnight and then the culture liquid was centrifuged at a low speed (5000 rpm) for 20 minutes to obtain about 5 g (wet weight) of fungus body. The fungus body was suspended in a 10 mM phosphate buffer (pH 7.0) (buffer 1) containing 40 mL of 1 mM ethylenediamine tetraacetate (EDTA) and, after the fungus body was destroyed on a French press, the mixture was centrifuged (20,000 rpm) for 20 minutes to separate a supernatant. Streptomycin sulfate was added to the resulting supernatant so that the final concentration was 2%. After stirred at 4° C. for 20 minutes, the mixture was centrifuged (20,000 rpm) for 20 minutes to separate a supernatant. Ammonium sulfate was added to the resulting supernatant so that the final concentration was 40%. After stirred at 4° C. for 20 minutes, the mixture was centrifuged (20,000 rpm) for 20 minutes to separate a supernatant. Ammonium sulfate was added to the resulting supernatant so that the final concentration was 90%. After stirred at 4° C. for 30 minutes, the mixture was centrifuged (20,000 rpm) for 20 minutes to separate a precipitate. The precipitate was dissolved in 40 mL of buffer 1 and the solution was dialyzed against 4 L of buffer 1 three times.

The dialyzed protein solution was applied to a column (200 ml) of DEAE TOYOPEARL (purchased from Tosoh Corp.) equilibrated with buffer 1 containing 50 mM KCl beforehand. After 500 mL of buffer 1 containing 50 mM KCl was charged, proteins were eluted using buffer 1 with a gradient of KCl concentration of 50 mM to 500 mM to separate a fraction containing the red fluorescent protein for immobilization. After the separated fraction was dialyzed against buffer 1, the resulting fraction was applied to a column (200 ml) of Super Q TOYOPEARL (purchased from Tosoh Corp.) equilibrated with buffer 1 containing 50 mM KCl beforehand. After 500 mL of buffer 1 containing 50 mM KCl was charged, proteins were eluted using buffer 1 with a gradient of KCl concentration of 50 mM to 500 mM to separate a fraction containing the red fluorescent protein for immobilization. At this stage, the protein could be homogenized and about 20 mg of a homogeneous red fluorescent protein for immobilization was obtained.

The resulting protein was stored against buffer 1 and the dialyzed sample was stored at 4° C. and used in the following experiments. The concentration of the red fluorescent protein for immobilization was determined based on absorbance at 280 nm using a molecular extinction coefficient of the red fluorescent protein represented by SEQ ID NO:2 of 36,000.

### (5) Alignment of Protein on Substrate for Array

On the polyallylamine-bound nylon film substrate and the polyallylamine-bound nitrocellulose film substrate produced in the above (1) and (2), adsorption alignment of the green fluorescent protein for immobilization or the red fluorescent protein for immobilization by static interaction was carried out using a capillary.

As the capillary, a commercially available tip for Pipette Man having an opening of a diameter of about 0.5 mm or a tip part of an ink pin for drawing having an opening of a diameter of about 0.2 mm was used.

In the case of the capillary having an opening of a diameter of about 0.5 mm, protein solutions having three kinds of concentration, i.e., 2 mg/ml, 1 mg/ml, and 0.5 mg/ml were prepared for the green fluorescent protein and protein solutions having three kinds of concentration, i.e., 0.5 mg/ml, 0.25 mg/ml, and 0.125 mg/ml were prepared for the red fluorescent protein. Then, 4 μl of each solution was spotted on four places and the appearance of adsorption on the planar substrate was investigated. Under natural light, since the red fluorescent protein showed stronger coloration than the green fluorescent protein showed and hence it is possible to detect the former protein even in a smaller amount, an experiment using a smaller amount of the protein is carried out with the red fluorescent protein.

With regard to the capillary having a diameter of about 0.2 mm, an experiment is carried out only with the red fluorescent protein and two kinds of concentrations, i.e., 0.4 mg/ml and 0.2 mg/ml of the protein solutions were prepared. Then, 0.5 μl of each solution was spotted on three places for the solution of 0.4 mg/ml and on two places for the solution of 0.2 mg/ml and the appearance of adsorption on each substrate was investigated.

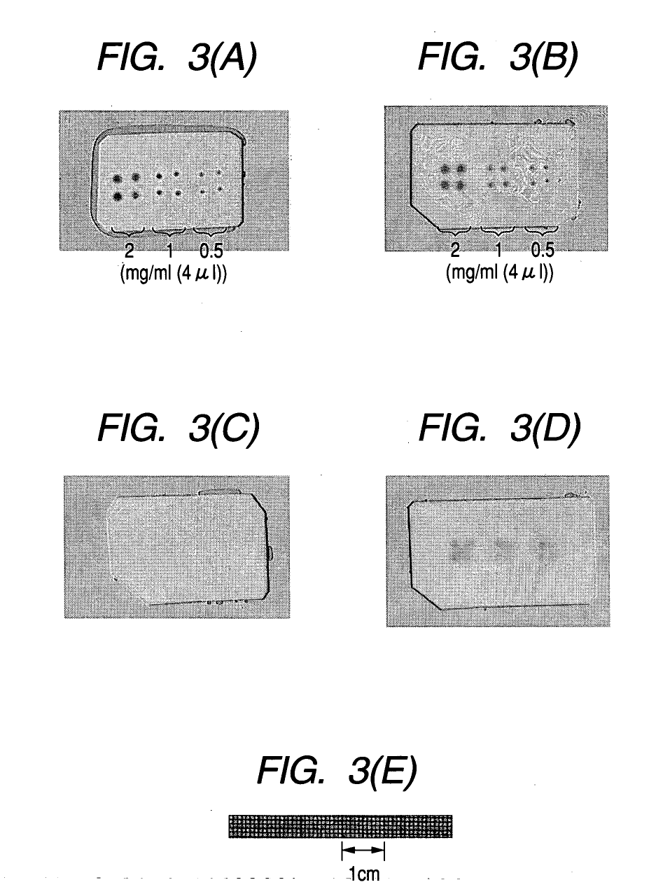

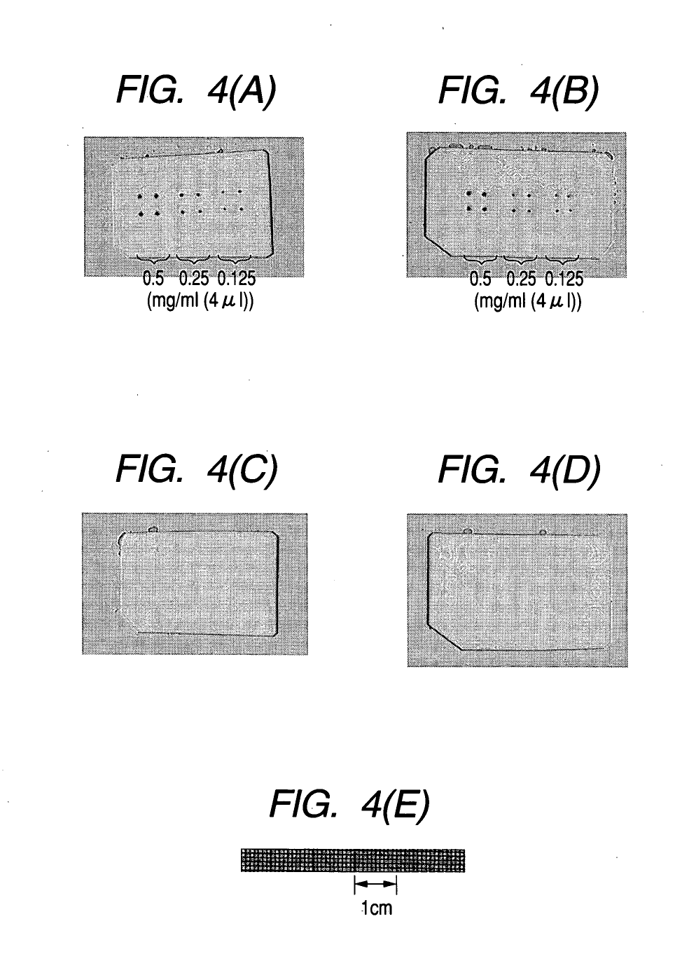

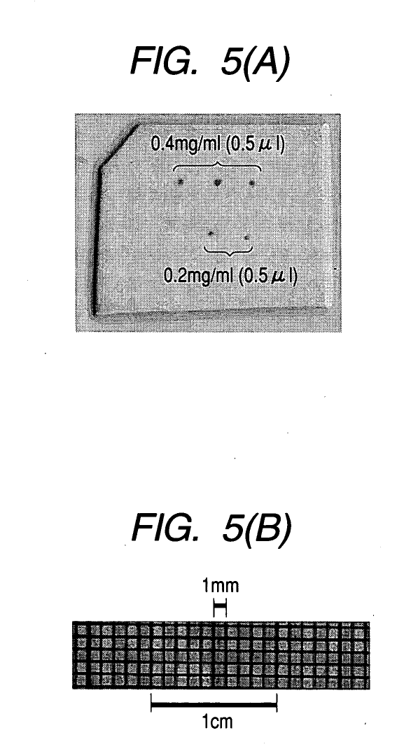

The polyallylamine-bound nylon film substrate and nitrocellulose film substrate both showed water absorbability and thus, so long as about several μl of the protein solution was used, the whole amount thereof was absorbed on the film when the opening of the capillary was only brought into contact with the film. At that time, the protein remained at the spotted place by static interaction and the size of the spot was spread depending on the concentration of the protein solution used but it was found that the protein remained within a smaller region than the size of the opening, so long as the protein was used in an amount of about 2 μg/mm² (see FIG. 3, FIG. 4, and FIG. 5). On the other hand, the solution (solvent) other than the protein diffused in all directions with the spotted place being the center.

Also, the protein adsorbed on the polyallylamine-bound substrate was eliminated from the substrate by thoroughly washing it with 1M KCl before subjection to the immobilization reaction shown in the following (7). This fact showed that the protein for immobilization rapidly adsorbs on the substrate by the action of static interaction between negative charges derived from Ala-Asp-Asp-Asp-Asp-Asp-Asp in the added amino acid sequence and positive charges derived from polyallylamine on the substrate and thus usefulness of aligning the protein beforehand using static interaction was confirmed.

### (7) Immobilization Reaction

The polyallylamine-bound substrate on which the green fluorescent protein for immobilization or the red fluorescent protein for immobilization was adsorbed in the above (6) was immersed in a 10 mM phosphate buffer (pH 7.0) containing 5 mM 2-nitro-5-thiocyanobenzoic acid (NTCB) with gentle stirring at room temperature for 4 hours to effect a cyanation reaction of the SH group of the cysteine residue. Then, after washed with 10 mM phosphate buffer (pH 7.0), the substrate was immersed in 10 mM borate buffer (pH 9.5) with gentle stirring at room temperature for 24 hours to effect an immobilization reaction. After completion of the immobilization reaction, the substrate was immersed in a 10 mM phosphate buffer (pH 7.0) containing 1M KCl with gentle stirring at room temperature for 24 hours or more to thereby remove unreacted protein and side reaction products. As a result, it was found that each protein was immobilized in high density in a planar small region as shown in FIG. 3, FIG. 4, and FIG. 5.

FIG. 3 shows a result of spotting three kinds of concentrations, i.e., 2 mg/ml, 1 mg/ml, and 0.5 mg/ml of the green fluorescent protein in an amount of 4 μl each on four places of each of polyallylamine-bound nylon film substrate (A) and polyallylamine-bound nitrocellulose film substrate (B) using a capillary having an opening of a diameter of about 0.5 mm and immobilizing the protein. It also shows a result of spotting the protein in the same manner on nylon film (C) and nitrocellulose film (D) not treated with polyallylamine and immobilizing the protein, which was carried out as a control. In the nitrocellulose film not treated with polyallylamine, non-specific adsorption was observed and widely spread thin spots were observed. Moreover, in the nylon film not treated with polyallylamine, non-specific adsorption was very little. On the other hand, in the polyallylamine-bound nylon film substrate and the polyallylamine-bound nitrocellulose film substrate, there were observed spots spread depending on the concentration of the protein solution used. When area was determined based on the diameter of the spot and total weight of the protein used for immobilization was considered, the density of the protein immobilized was found to be a value of about 2.8 to 2.2 μg/mm² in all the spots.

FIG. 4 shows a result of spotting three kinds of concentrations, i.e., 0.5 mg/ml, 0.25 mg/ml, and 0.125 mg/ml of the red fluorescent protein in an amount of 4 μl each on four places of each of polyallylamine-bound nylon film substrate (A) and polyallylamine-bound nitrocellulose film substrate (B) using a capillary having an opening of a diameter of about 0.5 mm and immobilizing the protein. It also shows a result of spotting the protein in the same manner on nylon film (C) and nitrocellulose film (D) not treated with polyallylamine and immobilizing the protein, which was carried out as a control. As in the case of the green fluorescent protein, in the nitrocellulose film not treated with polyallylamine, non-specific adsorption was observed and widely spread thin spots were observed. Moreover, in the nylon film not treated with polyallylamine, non-specific adsorption was very little. On the other hand, in the polyallylamine-bound nylon film substrate and the polyallylamine-bound nitrocellulose film substrate, there were observed spots spread depending on the concentration of the protein solution used, which were spots having a diameter of 1 mm or less. In each spot, the density of the protein immobilized was found to be a value of about 2.8 to 2.2 μg/mm².

FIG. 5 shows a result of spotting two kinds of concentrations, i.e., 0.4 mg/ml and 0.2 mg/ml of the red fluorescent protein in an amount of 0.5 μl each on three places of polyallylamine-bound nylon film substrate for the protein of 0.4 mg/ml and two places thereof for the protein of 0.2 mg/ml using a capillary having an opening of a diameter of about 0.2 mm and immobilizing the protein. In the case of spotting 0.5 μl×0.2 mg/ml, the protein could be spotted as a round spot having a diameter of about 0.2 mm, which was the same as the diameter of the capillary used. In this case, the density of the protein immobilized was also found to be about 2 μg/mm².

In every spot, both of the size and the color density were hardly changed even after the above process of the immobilization reaction. This fact shows that most of the proteins adsorbed are immobilized. Moreover, it was found that about 2 μg of the protein per mm² of the substrate area could be immobilized by using the substrates produced in (1) and (2) of Example. This value corresponds to a high density of about 100 to 1000 times the immobilized density when almost monomolecular protein is immobilized on a surface of a commercially available protein array in the thickness direction. Moreover, with regard to the size of the spots on the substrate, the smallest one has a size of about 0.1 mm on the commercially available protein array and the smallest one has a size of about 0.2 mm in the present Example but the size depends on the size of the opening (0.2 mm) of the capillary used. When a capillary or pin having a smaller opening is used or absorption is performed by an ink-jet process, the protein can be immobilized in a smaller region.

### INDUSTRIAL APPLICABILITY

As described in the above, according to the present invention, it is possible to control orientation of a protein and immobilize the protein with aligning it in high density in an extremely small region on a substrate for a protein array. Thereby, for example, in the case that the protein array is used for detection of various substances, a large number of detection tests can be carried out at once and detection sensitivity can be also improved. Furthermore, by aligning and immobilizing a protein having a catalytic function or a protein having a binding function with a specific substance to form a circuit, a novel micro-process substrate such as a microreactor or a microseparator can be created. In addition, since the protein to be immobilized in the protein array of the present invention is orientation-controlled and immobilized at one portion of the carboxyl terminal, the properties of the protein immobilized are homogeneous and the same properties in a solution can be maintained and hence the protein has the same structure and conformation as in the living body, so that it is extremely effective in diagnosis or the like by detecting in vivo substances or the like.

1. A substrate for a protein array, comprising a substrate to which a polymer compound having a primary amino group in a repeating structure is bound.

2. The substrate for a protein array according to claim 1, wherein the substrate to which the polymer compound having a primary amino group in a repeating structure is bound has water absorbability.

3. The substrate for a protein array according to claim 1, wherein the polymer compound having a primary amino group in a repeating structure is polyallylamine.

4. The substrate for a protein array according to claim 1, wherein the polymer compound having a primary amino group in a repeating structure is polylysine.

5. A protein array comprising a protein represented by formula (I) aligned and immobilized on the substrate for a protein array according to claim 1 so that the carboxyl terminal of the protein main chain represented by formula (I) is immobilized by a peptide bond to the primary amino group of the polymer compound bound to the substrate:
NH₂—R₁—COOH (I)
wherein R₁ represents any amino acid sequence.

6. A protein array comprising a protein represented by formula (IV) aligned and adsorbed on the substrate for a protein array according to claim 1 so that the protein represented by the above formula (IV) is immobilized in an adsorbed state:
NH₂—R₁—CONH—R₂—COOH (IV)
wherein R₁ represents any amino acid sequence; and R₂ represents an amino acid sequence which is negatively-charged strongly at around neutral and is capable of acidifying the isoelectric point of the protein represented by the above formula (IV).

7. The protein array according to claim 5, wherein the protein to be immobilized has an amino acid sequence of a linker peptide.

8. A process for producing a protein array comprising a protein represented by formula (I) aligned and immobilized on the substrate for a protein array according to claim 1:
NH₂—R₁—COOH (I)
wherein R₁ represents any amino acid sequence,
said method comprising reacting a protein represented by formula (II):
NH₂—R₁—CO—NH—CH(CH₂—SCN)—CO—NH—R₂—COO (II)
wherein R₁ represents any amino acid sequence; and R₂ represents an amino acid sequence which is negatively-charged strongly at around neutral and is capable of acidifying the isoelectric point of the protein represented by the above formula (II),
with a polymer compound on the substrate for a protein array to thereby bind the carboxyl terminal of the protein main chain of formula (II) to a primary amino group of the polymer compound by a peptide bond.

9. The process for producing a protein array according to claim 8, wherein the protein represented by formula (II) is formed by aligning and adsorbing a protein represented by formula (III):
NH₂—R₁—CONH—CH(CH₂—SH)—CO—NH—R₂—COOH (III)
wherein R₁ represents any amino acid sequence; and R₂ represents an amino acid sequence which is negatively-charged strongly at around neutral and is capable of acidifying the isoelectric point of the protein represented by the above formula (III),
on a substrate for a protein array, followed by reaction with a cyanation reagent.

10. A process for producing a protein array, which comprises aligning and adsorbing a protein represented by formula (IV):
NH₂—R₁—CONH—R₂—COOH (IV)
wherein R₁ represents any amino acid sequence; and R₂ represents an amino acid sequence which is negatively-charged strongly at around neutral and is capable of acidifying the isoelectric point of the protein represented by the above formula (IV),
on the substrate for a protein array according to claim 1 to thereby immobilize the protein in an adsorbed state.

11. The process for producing a protein array according to claim 8, wherein the protein to be immobilized has an amino acid sequence of a linker peptide.

12. The process for producing a protein array according to claim 8, wherein a means for aligning the protein on the substrate for a protein array is a microcapillary or a needle-like article.

13. The process for producing a protein array according to claim 8, wherein a means for aligning the protein on the substrate for a protein array is an ink-jet process.

14. The process for producing a protein array according to claim 10, wherein the protein to be immobilized has an amino acid sequence of a linker peptide.

15. The process for producing a protein array according to claim 10, wherein a means for aligning the protein on the substrate for a protein array is a microcapillary or a needle-like article.

16. The process for producing a protein array according to claim 10, wherein a means for aligning the protein on the substrate for a protein array is an ink-jet process.


SEQUENCE LISTING (4 sequences)

SEQ ID NO: 1 - protein, 239 aa, Artificial sequence
  Green fluorescent protein
MASKGEELFTGVVPILVELDGDVNGHKFSVSGEGEGDATYGKLTLKFICTTGKLPVPWPTLVTTLCYGVQCFSRYPDHMKRHDFFKSAMPEGYVQERTIFFKDDGNYKTRAEVKFEGDTLVNRIELKGIDFKEDGNILGHKLEYNYNSHNVYIMADKQKNGIKVNFKTRHNIEDGSVQLADHYQQNTPIGDGPVLLPDNHYLSTQSALSKDPNEKRDHMVLLEFVTAAGITHGMDELYN

SEQ ID NO: 2 - protein, 225 aa, Artificial sequence
  Red fluorescent protein
MASSENVITEFMRFKVRMEGTVNGHEFEIEGEGEGRPYEGHNTVKLKVTKGGPLPFAWDILSPQFQYGSKVYVKHPADIPDYKKLSFPEGFKWERVMNFEDGGVATVTQDSSLQDGCFIYKVKFIGVNFPSDGPVMQKKTMGWEASTERLYPRDGVLKGETHKALKLKDGGHYLVEFKSIYMAKKPVQLPGYYYVDAKLDITSHNEDYTIVEQYERTEGRHHLFL

SEQ ID NO: 3 - protein, 253 aa, Artificial sequence
  Green fluorescent protein combined with an amino acid sequence represented by Gly-Gly-Gly-Gly-Gly-Gly-Cys-Ala-Asp-Asp-Asp-Asp-Asp-Asp at the carboxyl terminal side
MASKGEELFTGVVPILVELDGDVNGHKFSVSGEGEGDATYGKLTLKFICTTGKLPVPWPTLVTTLCYGVQCFSRYPDHMKRHDFFKSAMPEGYVQERTIFFKDDGNYKTRAEVKFEGDTLVNRIELKGIDFKEDGNILGHKLEYNYNSHNVYIMADKQKNGIKVNFKTRHNIEDGSVQLADHYQQNTPIGDGPVLLPDNHYLSTQSALSKDPNEKRDHMVLLEFVTAAGITHGMDELYNGGGGGGCADDDDDD

SEQ ID NO: 4 - protein, 239 aa, Artificial sequence
  Red fluorescent protein combined with an amino acid sequencerepresented by Gly-Gly-Gly-Gly-Gly-Gly-Cys-Ala-Asp-Asp-Asp-Asp-Asp-Asp at the carboxyl terminal side
MASSENVITEFMRFKVRMEGTVNGHEFEIEGEGEGRPYEGHNTVKLKVTKGGPLPFAWDILSPQFQYGSKVYVKHPADIPDYKKLSFPEGFKWERVMNFEDGGVATVTQDSSLQDGCFIYKVKFIGVNFPSDGPVMQKKTMGWEASTERLYPRDGVLKGETHKALKLKDGGHYLVEFKSIYMAKKPVQLPGYYYVDAKLDITSHNEDYTIVEQYERTEGRHHLFLGGGGGGCADDDDDD